(19) United States
(12) Patent Application Publication
(10) Pub. No.: US 2026/0162456 A1
(43) Pub. Date: Jun. 11, 2026

(54) IMAGE PROCESSING APPARATUS, IMAGE PROCESSING METHOD, AND NON-TRANSITORY STORAGE MEDIUM

(71) Applicant: NEC Corporation, Minato-ku, Tokyo (JP)

(72) Inventor: Noboru YOSHIDA, Tokyo (JP)

(73) Assignee: NEC Corporation, Minato-ku, Tokyo (JP)

(21) Appl. No.: 18/707,917

(22) PCT Filed: Nov. 15, 2021
(86) PCT No.: PCT/JP2021/041924

§ 371 Date: May 7, 2024

(51) Int. Cl. G06V 40/10; G06V 10/44; G06V 10/764

(52) U.S. Cl. CPC G06V 40/10; G06V 10/44; G06V 10/764

(57) ABSTRACT

An image processing apparatus (100) according to the present invention detects a plurality of key points associated with each of a plurality of parts of a human body, computes a feature value of each of the key points, and computes an integrated feature value of each of the parts by integrating the feature values detected from a plurality of human bodies for each of the parts. When the key point associated with a first part of the plurality of parts is not detected from some of the plurality of human bodies, and the key point associated with the first part is detected from others of the plurality of human bodies, the image processing apparatus (100) computes the integrated feature value of the first part, based on the feature value of the key point associated with the first part detected from the others.

### TECHNICAL FIELD

The present invention relates to an image processing apparatus, an image processing method, and a program.

### BACKGROUND ART

Techniques relating to the present invention are disclosed in Patent Document 1 and Non-Patent Document 1. Patent Document 1 discloses a technique of computing a feature value of each of a plurality of key points of a human body included in an image, and searching for an image including a human body with a similar pose or a human body with a similar movement or classifying entities with the similar pose or the similar movement into a collective group, based on the feature value being computed. Further, Non-Patent Document 1 discloses a technique relating to skeletal estimation of a person.

### RELATED DOCUMENT

### Patent Document

Patent Document 1: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### DISCLOSURE OF THE INVENTION

### Technical Problem

When a search or classification disclosed in Patent Document 1 is performed by using an image in which a part of a human body is obscured from view by another object or another part of the human body, accuracy is degraded. Such inconvenience can be alleviated by using an image in which no part of a human body is obscured and all key points can be detected. However, preparing such an image may be challenging at times.

The present invention has an object to improve accuracy in a technique of searching for an image including a human body with a similar pose or movement or classifying images including a human body with a similar pose or movement into a collective group.

### Solution to Problem

According to the present invention, there is provided an image processing apparatus including:
a skeleton structure detection unit that executes processing of detecting a plurality of key points associated with each of a plurality of parts of a human body included in an image;
a feature value computation unit that computes a feature value of each of the key points being detected; and
a processing unit that computes an integrated feature value of each of the parts by integrating the feature values detected from a plurality of human bodies for each of the parts, and performs an image search or image classification, based on the integrated feature value, wherein,
when the key point associated with a first part of the plurality of parts is not detected from some of the plurality of human bodies, and the key point associated with the first part is detected from others of the plurality of human bodies, the processing unit computes the integrated feature value of the first part, based on the feature value of the key point associated with the first part detected from the others.

Further, according to the present invention, there is provided an image processing method including,
by a computer executing:
a skeleton structure detection step of executing processing of detecting a plurality of key points associated with each of a plurality of parts of a human body included in an image;
a feature value computation step of computing a feature value of each of the key points being detected; and
a processing step of computing an integrated feature value of each of the parts by integrating the feature values detected from a plurality of human bodies for each of the parts, and performing an image search or image classification, based on the integrated feature value,
the image processing method further including,
by the computer,
in the processing step, when the key point associated with a first part of the plurality of parts is not detected from some of the plurality of human bodies, and the key point associated with the first part is detected from others of the plurality of human bodies, computing the integrated feature value of the first part, based on the feature value of the key point associated with the first part detected from the others.

Further, according to the present invention, there is provided a program causing a computer to function as:
a skeleton structure detection unit that executes processing of detecting a plurality of key points associated with each of a plurality of parts of a human body included in an image;
a feature value computation unit that computes a feature value of each of the key points being detected; and
a processing unit that computes an integrated feature value of each of the parts by integrating the feature values detected from a plurality of human bodies for each of the parts, and performs an image search or image classification, based on the integrated feature value, wherein,
when the key point associated with a first part of the plurality of parts is not detected from some of the plurality of human bodies, and the key point associated with the first part is detected from others of the plurality of human bodies, the processing unit computes the integrated feature value of the first part, based on the feature value of the key point associated with the first part detected from the others.

### Advantageous Effects of Invention

According to the present invention, it is possible to improve accuracy in a technique of searching for an image including a human body with a similar pose or movement or classifying images including a human body with a similar pose or movement into a collective group.

### BRIEF DESCRIPTION OF THE DRAWINGS

The object described above, other objects, features, and advantages become clearer with reference to public example embodiments described above and the following drawings accompanying therewith.

FIG. 1 It is a diagram illustrating one example of processing of computing an integrated feature value from a still image according to the present example embodiment.

FIG. 2 It is a diagram illustrating one example of a hardware configuration of an image processing apparatus according to the present example embodiment.

FIG. 3 It is a diagram illustrating one example of a function block diagram of the image processing apparatus according to the present example embodiment.

FIG. 4 It is a diagram illustrating one example of a skeleton structure of a human body model to be detected by the image processing apparatus according to the present example embodiment.

FIG. 5 It is a diagram illustrating one example of a skeleton structure of a human body model detected by the image processing apparatus according to the present example embodiment.

FIG. 6 It is a diagram illustrating one example of a skeleton structure of a human body model detected by the image processing apparatus according to the present example embodiment.

FIG. 7 It is a diagram illustrating one example of feature values of key points that are computed by the image processing apparatus according to the present example embodiment.

FIG. 8 It is a diagram illustrating one example of feature values of key points that are computed by the image processing apparatus according to the present example embodiment.

FIG. 9 It is a diagram illustrating one example of feature values of key points that are computed by the image processing apparatus according to the present example embodiment.

FIG. 10 It is a diagram illustrating one example of processing of computing an integrated feature value from a moving image according to the present example embodiment.

FIG. 11 It is a diagram illustrating one example of processing of determining a correlation between frame images according to the present example embodiment.

FIG. 12 It is a diagram illustrating one example of the processing of computing an integrated feature value from a moving image according to the present example embodiment.

FIG. 13 It is a flowchart illustrating one example of a flow of processing of the image processing apparatus according to the present example embodiment.

FIG. 14 It is a flowchart illustrating one example of a flow of processing of the image processing apparatus according to the present example embodiment.

FIG. 15 It is a diagram for describing one example of the processing of computing an integrated feature value from a still image according to the present example embodiment.

FIG. 16 It is a diagram for describing one example of the processing of computing an integrated feature value from a still image according to the present example embodiment.

FIG. 17 It is a diagram for describing one example of the processing of computing an integrated feature value from a still image according to the present example embodiment.

FIG. 18 It is a diagram for describing one example of the processing of computing an integrated feature value from a still image according to the present example embodiment.

FIG. 19 It is a diagram for describing one example of the processing of computing an integrated feature value from a moving image according to the present example embodiment.

FIG. 20 It is a diagram for describing one example of the processing of computing an integrated feature value from a moving image according to the present example embodiment.

FIG. 21 It is a diagram illustrating one example of a function block diagram of the image processing apparatus according to the present example embodiment.

FIG. 22 It is a diagram schematically illustrating one example of information displayed by the image processing apparatus according to the present example embodiment.

FIG. 23 It is a diagram schematically illustrating one example of information displayed by the image processing apparatus according to the present example embodiment.

FIG. 24 It is a flowchart illustrating one example of a flow of processing of the image processing apparatus according to the present example embodiment.

FIG. 25 It is a diagram illustrating one example of a function block diagram of the image processing apparatus according to the present example embodiment.

FIG. 26 It is a diagram illustrating one example of a function block diagram of the image processing apparatus according to the present example embodiment.

FIG. 27 It is a diagram schematically illustrating one example of information displayed by the image processing apparatus according to the present example embodiment.

### DESCRIPTION OF EMBODIMENTS

Example embodiments of the present invention are described below with reference to the drawings. Note that, in all the drawings, a similar constituent element is denoted with a similar reference sign, and description therefor is omitted as appropriate.

### First Example Embodiment

### Overview

An image processing apparatus according to the present example embodiment detects a key point associated with each part of a human body (hereinafter, a “part of a human body” may be simply referred to as a “part”) from each of a plurality of human bodies, integrates a feature value of the key point for each part, and computes an integrated feature value for each part. Further, the image processing apparatus performs an image search or image classification, based on the integrated feature value being computed for each part. According to the image processing apparatus described above, when a certain key point is not detected from one human body, it can be complemented with a feature value of the key point detected from another human body. Thus, the integrated feature value associated with each of all the parts can be computed.

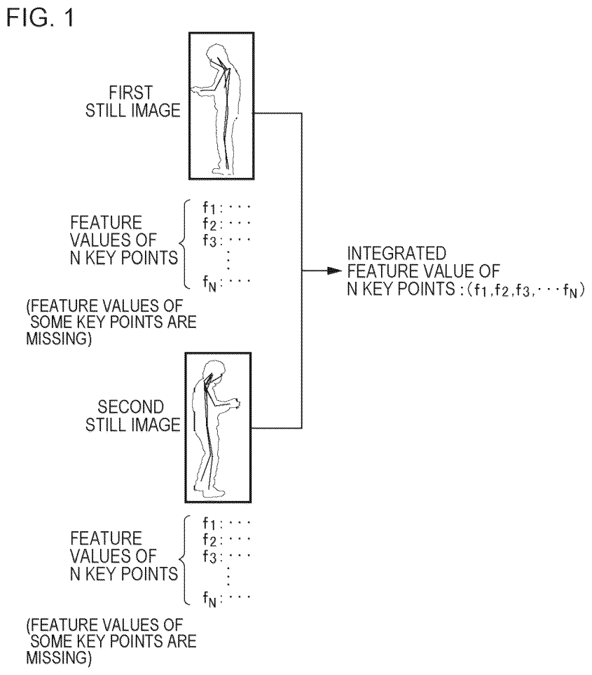

With reference to FIG. 1, one example of processing of computing an integrated feature value is described. A first still image illustrated herein is an image acquired by capturing a person, who is washing a hand, from a left side of the person. In the first still image, a right side of a body of the person is partially obscured. When the first still image described above is subjected to processing of detecting N key points of a human body, some of the N key points, in other words, key points included in parts that are not obscured are detected, but others of the N key points, in other words, key points included in parts that are obscured are not detected. As a result, in this state, some feature values of the key points are missing.

Similarly, a second still image is an image acquired by capturing a person, who is washing a hand, from the right side of the person. In the second still image, the left side of a body of the person is partially obscured. When the second still image described above is subjected to processing of detecting N key points of a human body, some of the N key points, in other words, key points included in parts that are not obscured are detected, but others of the N key points, in other words, key points included in parts that are obscured are not detected. As a result, in this state, some feature values of the key points are missing.

When the image processing apparatus according to the present example embodiment integrates the feature value of the key point detected from the human body included in the first still image and the feature value of the key point detected from the human body included in the second still image, the feature value of the key point not being detected from the human body included in the first still image can be complemented with the feature value of the key point being detected from the human body included in the second still image. Similarly, the feature value of the key point not being detected from the human body included in the second still image can be complemented with the feature value of the key point being detected from the human body included in the first still image. As a result, integrated feature values associated with all the N parts can be computed. Further, searching for an image including a human body with a similar pose or movement or classifying images including a human body with a similar pose or movement into a collective group is performed by using the integrated feature values associated with all the N parts, and thereby accuracy is improved.

### Hardware Configuration

Next, one example of a hardware configuration of the image processing apparatus is described. Each of function units of the image processing apparatus is achieved by any combination of hardware and software that mainly include a central processing unit (CPU) of any computer, a memory, a program loaded into the memory, a storage unit such as a hard disk for storing the program (capable of storing a program downloaded from a storage medium such as a compact disc (CD), a server on the Internet, or the like, in addition to a program stored in advance in an apparatus at a time of shipping), and an interface for network connection. Further, a person skilled in the art understands that various modification examples may be made to the implementation method and the apparatus.

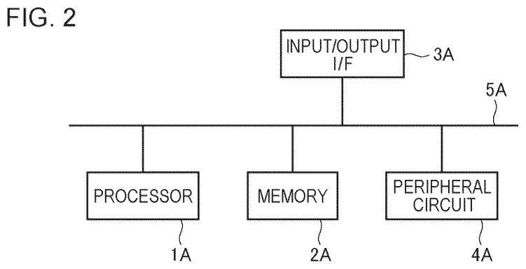

FIG. 2 is a block diagram illustrating a hardware configuration of the image processing apparatus. As illustrated in FIG. 2, the image processing apparatus includes a processor 1A, a memory 2A, an input/output interface 3A, a peripheral circuit 4A, and a bus 5A. The peripheral circuit 4A includes various modules. The image processing apparatus may not include the peripheral circuit 4A. Note that, the image processing apparatus may be configured by a plurality of apparatuses that are separated physically and/or logically. In this case, each of the plurality of apparatuses may include the above-mentioned hardware.

The bus 5A is a data transmission path in which the processor 1A, the memory 2A, the peripheral circuit 4A, and the input/output interface 3A mutually transmit and receive data. For example, the processor 1A is an arithmetic processing apparatus such as a CPU and a graphics processing unit (GPU). For example, the memory 2A is a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Examples of the input apparatus include, for example, a keyboard, a mouse, a microphone, a physical button, a touch panel, and the like. Examples of the output apparatus include, for example, a display, a speaker, a printer, a mailer, and the like. The processor 1A is capable of issuing a command to each of the modules and executing an arithmetic operation, based on the arithmetic operation results.

### Functional Configuration

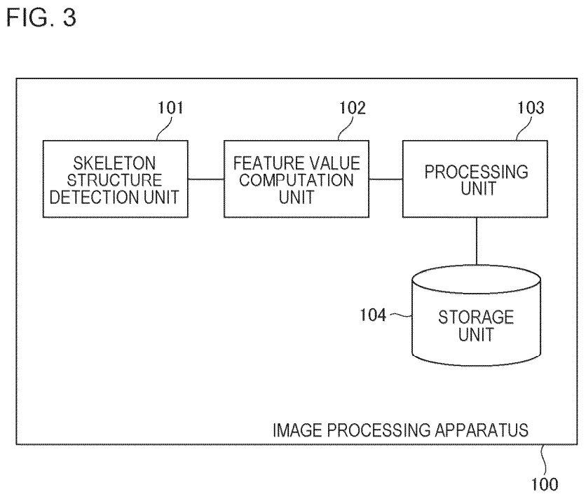

FIG. 3 illustrates one example of a function block diagram of an image processing apparatus 100 according to the present example embodiment. The image processing apparatus 100 illustrated herein includes a skeleton structure detection unit 101, a feature value computation unit 102, a processing unit 103, and a storage unit 104. Note that, the image processing apparatus 100 may not include the storage unit 104. In this case, an external apparatus includes the storage unit 104. Further, the storage unit 104 is configured to be accessible from the image processing apparatus 100.

The skeleton structure detection unit 101 executes processing of detecting N key points (N is an integer equal to or greater than 2) associated with each of a plurality of parts of a human body included in an image. The image is a concept including a still image and a moving image. When a moving image is subjected to processing, the skeleton structure detection unit 101 executes processing of detecting a key point for each frame image. The processing executed by the skeleton structure detection unit 101 is achieved by using the technique disclosed in Patent Document 1. Although details thereof are omitted, in the technique disclosed in Patent Document 1, detection of a skeleton structure is performed by using a skeleton estimation technique such as OpenPose disclosed in Non-Patent Document 1. A skeleton structure detected by the technique is configured by a “key point” being a feature point such as a joint and a “bone (bone link)” indicating a link between the key points.

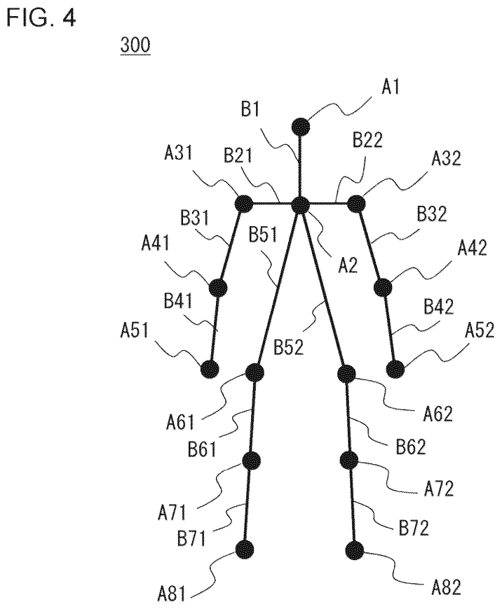

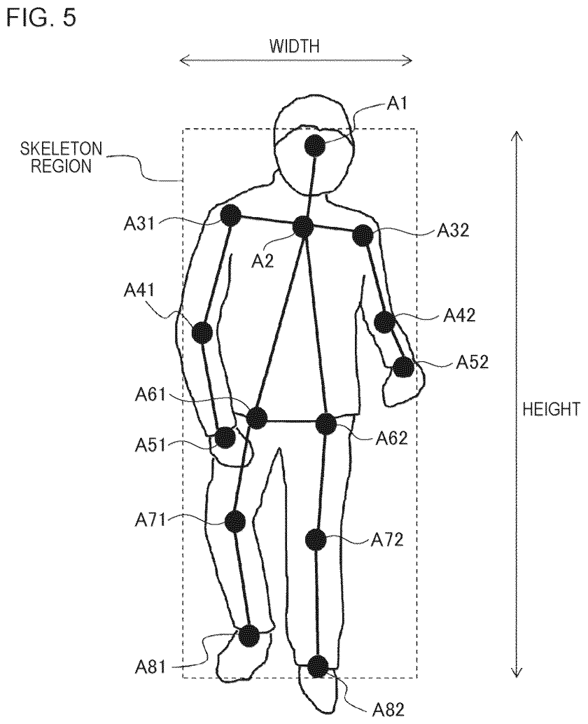

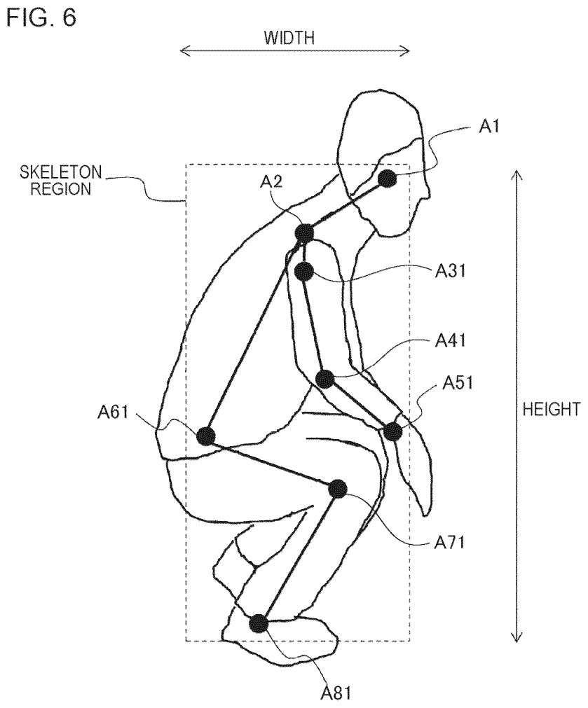

FIG. 4 illustrates a skeleton structure of a human body model 300 to be detected by the skeleton structure detection unit 101, and FIGS. 5 and 6 illustrate detection examples of the skeleton structure. The skeleton structure detection unit 101 detects the skeleton structure of the human body model (two-dimensional skeleton model) 300 as in FIG. 4 from a two-dimensional image by using a skeleton estimation technique such as OpenPose. The human body model 300 is a two-dimensional model being configured by a key point such as a human joint and a bone connecting each of the key points.

For example, the skeleton structure detection unit 101 extracts a keypoint that may function as a key point from an image, and detects N key points of a human body with reference to information performed machine learning from the image of the key point. The N key points to be detected are determined in advance. The number of key points to be detected (in other words, the number N) or a part of a human body being determined as the key point may vary, and any variation may be adopted.

In the following description, as illustrated in FIG. 4, it is assumed that a head A1, a neck A2, a right shoulder A31, a left shoulder A32, a right elbow A41, a left elbow A42, a right hand A51, a left hand A52, a right hip A61, a left hip A62, a right knee A71, a left knee A72, a right foot A81, and a left foot A82 are determined as the N key points (N=14) being detection targets. Note that, in the human body model 300 illustrated in FIG. 4, as human bones that connect those key points, a bone B1 that connects the head A1 and the neck A2, a bone B21 and a bone B22 that connect the neck A2, and each of the right shoulder A31 and the left shoulder A32, respectively, a bone B31 and a bone B32 that connect the right shoulder A31 and the right elbow A41, and the left shoulder A32 and the left elbow A42, respectively, a bone B41 and a bone B42 that connect the right elbow A41 and the right hand A51, and the left elbow A42 and the left hand A52, respectively, a bone B51 and a bone B52 that connect the neck A2, and each of the right hip A61 and the left hip A62, respectively, a bone B61 and a bone B62 that connect the right hip A61 and the right knee A71, and the left hip A62 and the left knee A72, respectively, and a bone B71 and a bone B72 that connect the right knee A71 and the right foot A81, and the left knee A72 and the left foot A82, respectively, are further determined.

FIG. 5 is an example in which key points are detected from a human body in an upright position. In FIG. 5, an image of an upright human body is captured from a front, and all the fourteen key points are detected. FIG. 6 is an example in which key points are detected from a human body in a squatting position. In FIG. 6, an image of a squatting human body is captured from a right side, and only some of the fourteen key points are detected. Specifically, in FIG. 6, the head A1, the neck A2, the right shoulder A31, the right elbow A41, the right hand A51, the right hip A61, the right knee A71, and the right foot A81 are detected, and the left shoulder A32, the left elbow A42, the left hand A52, the left hip A62, the left knee A72, and the left foot A82 are not detected.

Referring back to FIG. 3, the feature value computation unit 102 computes a feature value of the two-dimensional skeleton structure being detected. For example, the feature value computation unit 102 computes a feature value of each of the key points being detected.

The feature value of the skeleton structure indicates a feature of a skeleton of a person, and functions as an element for classifying or searching for a state (pose or movement) of the person, based on the skeleton of the person. In general, the feature value includes a plurality of parameters. Further, the feature value may be a feature value of the entire skeleton structure or a feature value of a part of the skeleton structure, or may include a plurality of feature values of each part of the skeleton structure. A method of computing a feature value may be any method such as machine learning and normalization, and a minimum value or a maximum value may be acquired through normalization. In one example, the feature value is a feature value acquired through machine learning of a skeleton structure, a size of a skeleton structure from a head portion to a foot portion in an image, a relative positional relationship of a plurality of key points in an up-and-down direction of a skeleton region including a skeleton structure in an image, a relative positional relationship of a plurality of key points in a right-and-left direction of the skeleton region, or the like. The size of the skeleton structure is a height in the up-and-down direction, an area, or the like of a skeleton region including a skeleton structure in an image. The up-and-down direction (a height direction or a vertical direction) is an upward and downward direction (Y-axis direction) in an image, and is a direction vertical to the ground (reference surface), for example. Further, the right-and-left direction (a horizontal direction) is a rightward and leftward direction (X-axis direction) in an image, and is a direction parallel to the ground, for example.

Note that, a feature value having robustness with respect to classification or search processing is preferably used in order to perform classification or a search being desirable for a user. For example, when a user desires classification or a search that does not depend on an orientation or a body shape of a person, a feature value having robustness with respect to an orientation or a body shape of a person may be used. A feature value that does not depend on an orientation or a body shape of a person can be acquired by learning skeletons of persons oriented in various directions in the same pose or skeletons of persons in various body shapes in the same pose, or extracting features limited to the up-and-down direction of a skeleton.

The above-mentioned processing executed by the feature value computation unit 102 is achieved by using the technique disclosed in Patent Document 1.

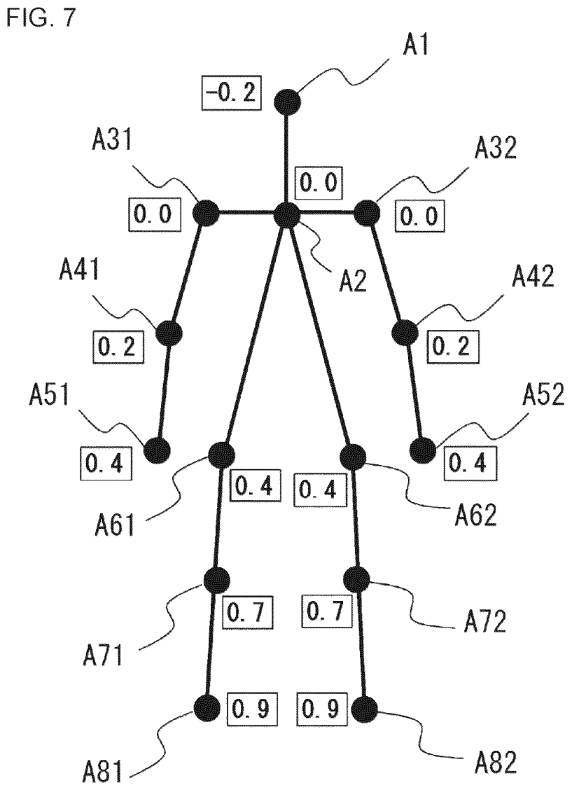

FIG. 7 illustrates an example of feature values of a plurality of key points acquired by the feature value computation unit 102. Note that, the feature values of the key points illustrated herein are merely one example, and are not limited thereto.

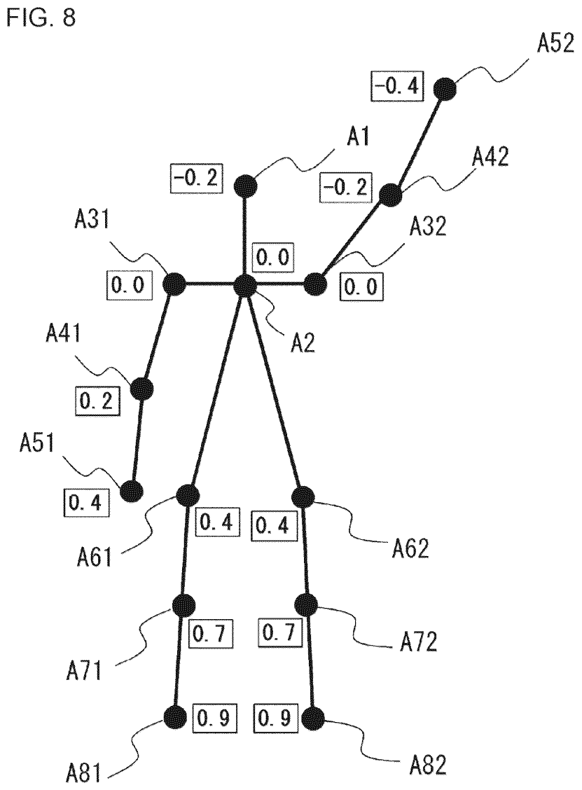

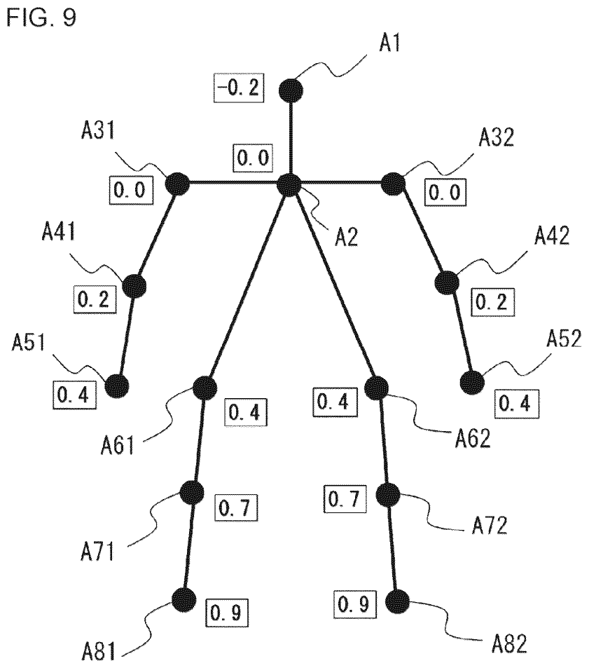

In this example, the feature value of the key point indicates a relative positional relationship of the plurality of key points in the up-and-down direction of the skeleton region including the skeleton structure in an image. Since the key point A2 being a neck functions as a reference point, the feature value of the key point A2 is 0.0, and the feature values of the key point A31 being a right shoulder and the key point A32 being a left shoulder that are at the same height of the neck are also 0.0. The feature value of the key point Al being a head that is higher than the neck is −0.2. The feature values of the key point A51 being a right hand and the key point A52 being a left hand that are lower than the neck are 0.4, and the feature values of the key point A81 being a right foot and the key point A82 being a left foot are 0.9. When the person raises the left hand from this state, the left hand becomes higher than the reference point as illustrated in FIG. 8, and hence the feature value of the key point A52 being a left hand becomes −0.4. Meanwhile, even when, as illustrated in FIG. 9, a width of the skeleton structure is changed as compared to FIG. 7, the feature value is not changed since normalization is performed by using only the Y-axis coordinate. In other words, the feature value (normalization value) in this example indicates a feature of the skeleton structure (key point) in the height direction (Y direction), and is not affected by a change of the skeleton structure in the horizontal direction (X direction).

Referring back to FIG. 3, the processing unit 103 integrates feature values of key points detected from each of M human bodies (M is an integer equal to or greater than 2) for each part, and thereby computes an integrated feature value for each part. Further, the processing unit 103 performs an image search or image classification, based on the integrated feature value for each part. Note that, as described above, the plurality of key points are associated with each of the plurality of parts. Thus, execution of the processing “for each part” has the same meaning as execution of the processing “for each key point”. For example, the “integrated feature value for each part” being acquired by computation for each part has the same meaning as the “integrated feature value of each of the N key points” being acquired by computation for each key point.

### Processing of Computing Integrated Feature Value

Case in which Still Image is subjected to Processing

First, a user specifies M human bodies to be subjected to processing of computing an integrated feature value. For example, a user may specify the M human bodies by specifying M still images each including one human body (specifying M still image files). For example, specification of the M still images is an operation of inputting the M still images to the image processing apparatus 100, an operation of selecting the M still images from a plurality of still images stored in the image processing apparatus 100, or the like. In this case, the skeleton structure detection unit 101 described above executes processing of detecting the N key points for each of the M still images being specified. Note that, all the N key points may be detected, or only some of the N key points may be detected. The feature value computation unit 102 computes the feature value of each of the key points being detected.

Alternatively, a user may specify the M human bodies by specifying at least one still image (specifying at least one still image file) and also specifying M regions each including one human body in the at least one still image being specified. Note that, a plurality of regions (in other words, a plurality of human bodies) may be specified from one still image. Processing of specifying a partial region in a still image may be achieved by using various related-art techniques. In this case, the skeleton structure detection unit 101 described above executes the processing of detecting the N key points for each of the M regions being specified. Note that, all the N key points may be detected, or only some of the N key points may be detected. The feature value computation unit 102 computes the feature value of each of the key points being detected.

After the feature values of the key points of each of the M human bodies specified by a user are computed, the processing unit 103 integrates those values for each key point, and thereby computes the integrated feature value. For example, the processing unit 103 sequentially selects one key point from the N key points, and executes the processing of computing an integrated feature value. In the following description, a key point that is one of the N key points and is selected as a processing target is referred to as a “first key point”.

When the first key point is not detected from some of the M human bodies, and the first key point is detected from others of the M human bodies, the processing unit 103 computes an integrated feature value of the first key point (also referred to as an “integrated feature value of a first part”), based on the feature value of the first key point detected from the others. With the processing, the feature values of the key points that are computed from each of the plurality of human bodies can be integrated while complementing missing points with each other.

Note that, a detection state of the first key point is any of (1) detection from only one of the M human bodies, (2) detection from a plurality of human bodies of the M human bodies, and (3) detection from none of the M human bodies. The processing unit 103 is capable of computing the integrated feature value by processing associated with each of the detection states. Details thereof are described below.
(1) Detection from Only One of M Human Bodies

When the first key point is detected from only one of the M human bodies, the processing unit 103 regards, as the integrated feature value of the first key point, the feature value of the first key point detected from the one human body.
(2) Detection from Plurality of Human Bodies of M Human Bodies

When the first key point is detected from a plurality of human bodies of the M human bodies, the processing unit 103 computes the integrated feature value of the first key point by any of the following computation examples 1 to 4.
Computation Example 1

When the first key point is detected from a plurality of human bodies of the M human bodies, the processing unit 103 computes, as the integrated feature value of the first key point, a statistic value of the feature values of the first key points that are detected from the plurality of human bodies. The statistic value is an average value, a median value, a mode, a maximum value, or a minimum value.
Computation Example 2

When the first key point is detected from a plurality of human bodies of the M human bodies, the processing unit 103 regards, as the integrated feature value of the first key point, a feature value having the highest certainty factor among the feature values of the first key points that are detected from the plurality of human bodies. A method of computing the certainty factor is not particularly limited. For example, in a skeleton estimation technique such as OpenPose, a score being output in association with each of the key points being detected may be regarded as the certainty factor of each of the key points.
Computation Example 3

When the first key point is detected from a plurality of human bodies of the M human bodies, the processing unit 103 computes, as the integrated feature value of the first key point, a weighted average value of the feature value of the first key point according to a certainty factor of the feature value of the first key point detected from each of the plurality of human bodies. A method of computing the certainty factor is not particularly limited. For example, in a skeleton estimation technique such as OpenPose, a score being output in association with each of the key points being detected may be regarded as the certainty factor of each of the key points.
Computation Example 4

In advance, a user specifies a priority order of each of the M human bodies being specified. A content being specified is input to the image processing apparatus 100. Further, When the first key point is detected from a plurality of human bodies of the M human bodies, the processing unit 103 regards, as the integrated feature value of the first key point, the feature value of the first key point detected from the human body having the highest priority order among the plurality of human bodies from which the first key point is detected.
(3) Detection from None of M Human Bodies

When the first key point is detected from none of the M human bodies, the processing unit 103 does not compute the integrated feature value of the first key point.
Case in which Moving Image is subjected to Processing

First, a user specifies M human bodies to be subjected to processing of computing an integrated feature value. For example, a user may specify the M human bodies by specifying M moving images each including one human body (specifying M moving image files). For example, specification of the M moving images is an operation of inputting the M moving images to the image processing apparatus 100, an operation of selecting the M moving images from a plurality of moving images stored in the image processing apparatus 100, or the like. In this case, the skeleton structure detection unit 101 described above executes the processing of detecting the N key points for a frame image of each of the M moving images being specified. Note that, all the N key points may be detected, or only some of the N key points may be detected. The feature value computation unit 102 computes the feature value of each of the key points being detected.

Alternatively, a user may specify the M human bodies by specifying at least one moving image (specifying at least one moving image file) and also specifying M scenes (some scenes in the moving image, a scene consisting of some frame images of a plurality of frame image included in the moving image) or M regions each including one human body in the at least one moving image being specified. Note that, a plurality of scenes or a plurality of regions (in other words, a plurality of human bodies) may be specified from one moving image. Processing of specifying a partial scene or a partial region in a moving image may be achieved by using various related-art techniques. In this case, the skeleton structure detection unit 101 described above executes the processing of detecting the N key points for a frame image of each of the M scenes being specified (or a partial region in a frame image being specified by a user). Note that, all the N key points may be detected, or only some of the N key points may be detected. The feature value computation unit 102 computes the feature value of each of the key points being detected.

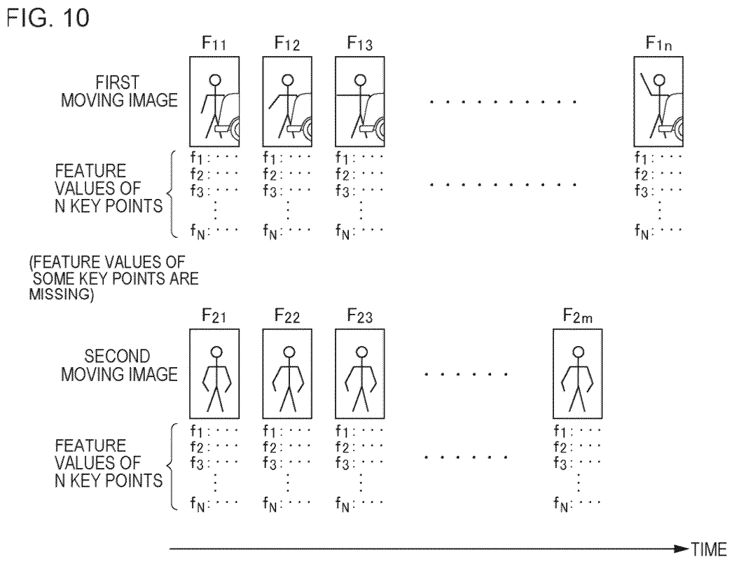

After the feature values of the key points of each of the M human bodies specified by a user are computed, the processing unit 103 integrates those values for each key point, and thereby computes the integrated feature value. The processing unit 103 determines a correlation between frame images in the M moving images or the M scenes, and integrates the feature values of the key points, which are detected from each of the plurality of frame images associated with each other, for each of the key points. With reference to FIGS. 10 to 12, details thereof are further described below.

FIG. 10 illustrates two (M=2) moving images (scenes). Each of them includes one human body. Further, each of them includes a plurality of frame images.

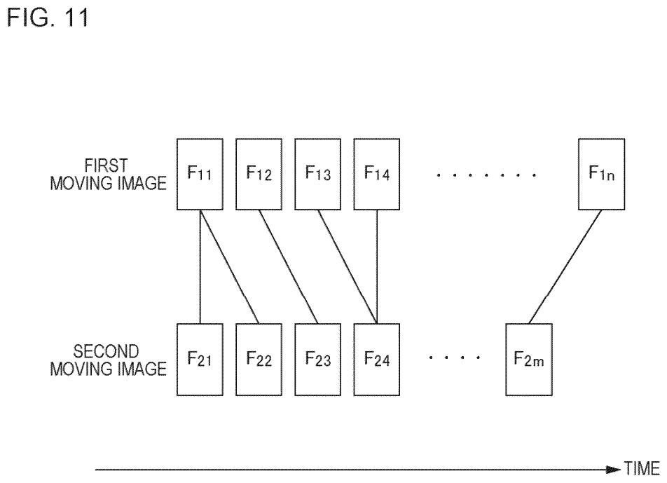

As illustrated in FIG. 11, the processing unit 103 associates frame images with each other in which a human body performing a predetermined movement in a first moving image and a human body performing the predetermined movement in a second moving image are in a similar pose. In FIG. 11, frame images that are associated with each other are connected by a line. Note that, as illustrated, one frame image of the first moving image may be associated with a plurality of frame images of the second moving image. Further, one frame image of the second moving image may be associated with a plurality of frame images of the first moving image. For example, determination of the above-mentioned correlation may be achieved by using a technique such as dynamic time warping (DTW). In such a case, a distance between the feature values (a Manhattan distance or a Euclidean distance) or the like may be used as a distance score required for determination of the correlation. According to the technique, as illustrated in FIG. 10, even when time lengths of the first moving image and the second moving image are different from each other (in other words, the numbers of frame images are different from each other), the above-mentioned correlation can be determined.

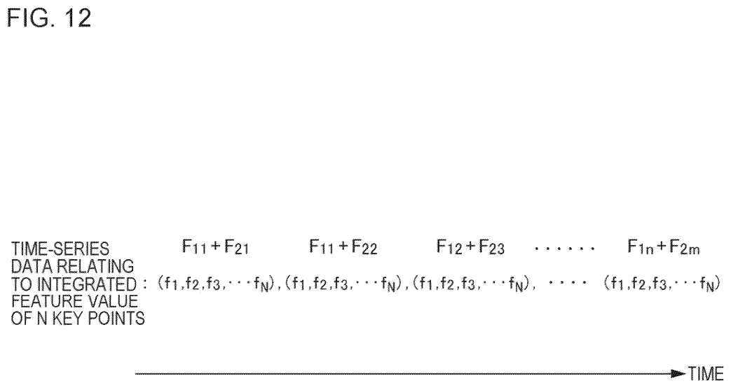

In this case, as illustrated in FIG. 12, the feature values of the N key points are computed for each combination of the plurality of frame images being associated with each other, and thereby acquires time-series data relating to integrated feature values of the N key points. F₁₁+F₂₁ in FIG. 12 is an integrated feature value of the N key points that are acquired by integrating feature values of key points of a human body detected from a frame image F₁₁ of the first moving image and feature values of key points of a human body detected from a frame image F₂₁ of the second moving image in FIG. 10. A method of integrating feature values of key points of a human body detected from an associated frame image is similar to the above-mentioned method of integrating feature values of key point of a human body detected from a still image.

### Image Search Processing

During image search processing, the processing unit 103 searches for a still image including a human body in a pose similar to a pose indicated by the integrated feature value, a moving image including a human body in a movement similar to a movement indicated by time-series data relating to the integrated feature value, or the like while using the integrated feature value computed based on the M human bodies specified by a user as described above, as a query. A search method can be achieved by using the technique disclosed in Patent Document 1.

### Image Classification Processing

During image classification processing, the processing unit 103 handles, as one target of classification processing, a pose or a movement indicated by the integrated feature value computed based on the M human bodies specified by a user as described above, and classifies entities with the similar pose or movement into a collective group. A classification method can be achieved by using the technique disclosed in Patent Document 1.

### Other Processing

The processing unit 103 may register a pose or a movement indicated by the integrated feature value computed based on the M human bodies specified by a user as described above, as one processing target, in a database (the storage unit 104). For example, a plurality of poses or movements that are registered in the database may be subjected to comparison with the query in the above-mentioned image search processing, or may be subjected to the classification processing in the above-mentioned image classification processing. For example, by capturing the same person by a plurality of cameras from a plurality of angles and specifying, as the above-mentioned M human bodies, a plurality of human bodies of the same person that are included in a plurality of images captured by the plurality of cameras, an integrated feature value indicating well a pose or a movement of the human body is computed and registered in the database.

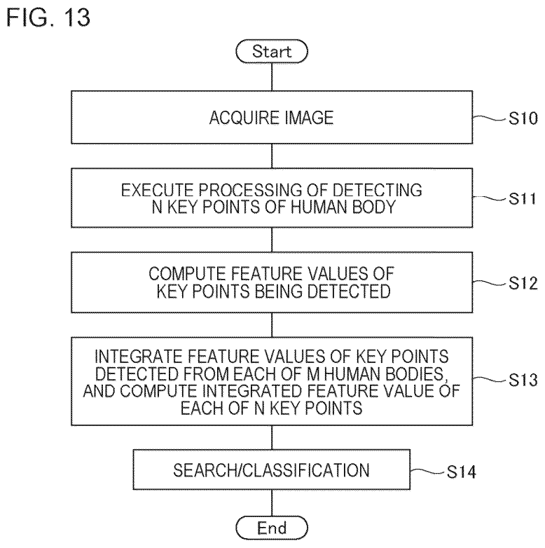

Next, one example of a flow of processing executed by the image processing apparatus 100 is described with reference to the flowchart in FIG. 13.

First, the image processing apparatus 100 acquires at least one image (S10). Subsequently, the image processing apparatus 100 executes the processing of detecting the N key points from each of the M human bodies included in the at least one image being acquired (S11). From each of the human bodies, all the N key points may be detected, or only some of the N key points may be detected.

Subsequently, the image processing apparatus 100 computes a feature value of the key point being detected for each of the human bodies (S12). Subsequently, the image processing apparatus 100 integrates the feature values of the key points detected from each of the M human bodies, and thereby computes an integrated feature value of each of the N key points (S13). Subsequently, the image processing apparatus 100 performs an image search or image classification, based on the integrated feature value computed in S13 (S14).

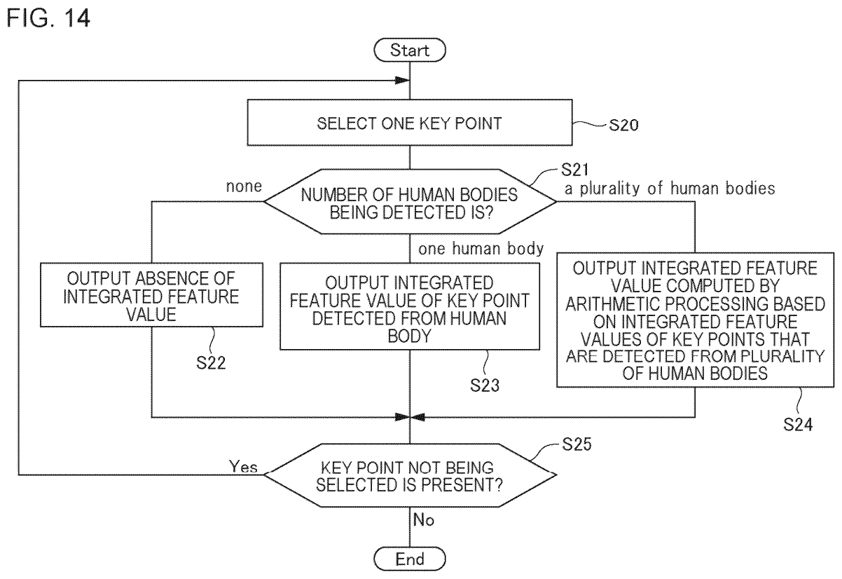

Herein, with reference to the flowchart in FIG. 14, one example of the processing in S13 is described in detail.

The image processing apparatus 100 selects one of the N key points as a processing target (S20). In the following description, the key point being selected is referred to as a first key point.

After that, the image processing apparatus 100 executes processing associated with the number of human bodies from which the first key points are detected. When the first key point is detected from only one of the M human bodies (“one human body” in S21), the image processing apparatus 100 outputs, as the integrated feature value of the first key point, the feature value of the first key point detected from the one human body (S23).

When the first key point is detected from a plurality of human bodies of the M human bodies (“a plurality of human bodies” in S21), the image processing apparatus 100 outputs, as the integrated feature value of the first key point, a value computed by arithmetic processing based on the feature values of the first key points that are detected from the plurality of human bodies (S24). The details of the arithmetic processing are as described above.

When the first key point is detected from none of the M human bodies (“none” in S21), the processing unit 103 does not compute the integrated feature value of the first key point, and outputs absence of the integrated feature value (S22).

### Advantageous Effects

In some cases, a part of a human body is obscured in an image by another object or another part of the own human body. When such an image is subjected to the processing by the technique disclosed in Patent Document 1, a key point of the obscured part is not detected, and a feature value thereof is not computed. Further, when a search/classification is performed based on only the feature value of some of the key points being detected, an image including a human body having at least one body part in a similar pose or a human body having at least one body part in a similar movement is searched, or images including at least one body part in a similar pose or movement are classified into a collective group. As a result, accuracy of the search or classification is degraded.

The image processing apparatus 100 according to the present example embodiment integrates feature values of key points detected from each of a plurality of human bodies, and thereby computes an integrated feature value of each of the plurality of key points. Further, the image processing apparatus performs an image search or image classification, based on the integrated feature value being computed. According to the image processing apparatus described above, a feature value of a key point not being detected from a certain human body can be complemented with a feature value of a key point being detected from another human body. Thus, the integrated feature value associated with each of all the key points can be computed. Further, an image search or image classification is performed based on the integrated feature value associated with each of all the key points, and thereby accuracy is improved.

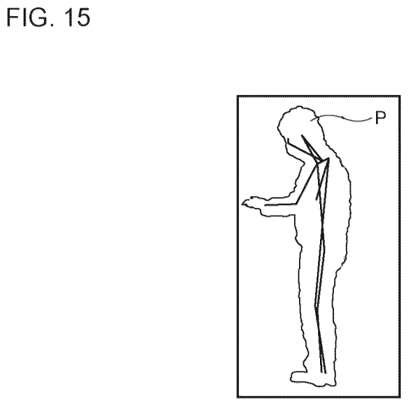

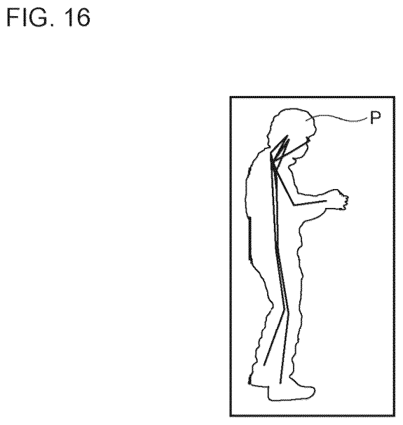

In the present example embodiment, N key points of a plurality of human bodies P illustrated in FIGS. 15 and 16 can be integrated, for example. A still image in FIG. 15 is an image acquired by capturing a person, who is washing a hand, from the left side of the person. In a first still image, the left side of the body of the person is visible, but the right side of the body is obscured. As a result, the key points included in the left side parts of the body of the person are detected, but the key points included in the right side parts are not detected. A still image in FIG. 16 is an image acquired by capturing a person, who is washing a hand, from the right side of the person. In a second still image, the right side of the body of the person is visible, but the left side of the body is obscured. As a result, the key points included in the right side parts of the body of the person are detected, but the key points included in the left side parts are not detected. By integrating the feature values of the key points of the human bodies that are detected from the two still images described above, missing parts are complemented with each other, and thereby the integrated feature value associated with each of all the N key points can be computed.

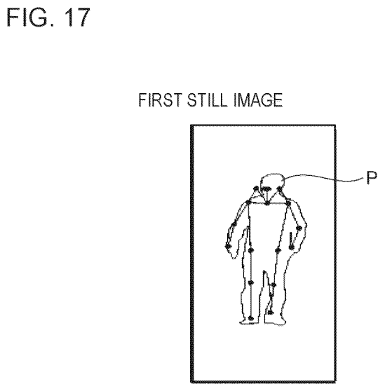

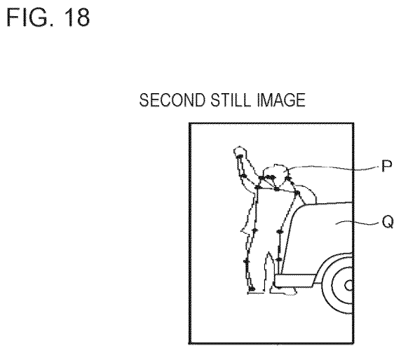

Further, in the present example embodiment, N key points of a plurality of human bodies P illustrated in FIGS. 17 and 18 can be integrated, for example. A still image in FIG. 17 is an image acquired by capturing a person, who is standing with a left hand on a hip, from the front side of the person. In a first still image, there is no obscured part of the body of the person. As a result, all the N key points are detected from the human body P. A still image in FIG. 18 is an image acquired by capturing a person, who is standing while raising a right hand, from the front side of the person. In a second still image, some parts of a left half body of the person are obscured by a vehicle Q. As a result, the key points included in the visible parts of the body of the person are detected, but the key points included in the obscured parts are not detected. By integrating the feature values of the key points of the human bodies that are detected from the two still images described above, missing parts in the second still image are complemented with the first image, and thereby the integrated feature value associated with each of all the N key points can be computed. In this example, for example, the above-mentioned method in the fourth example, in other words, computation of the integrated feature value, based on the priority order of each of the M human bodies, may be performed. For example, a user specifies a higher priority for the human body included in the second still image over the one included in the first still image. In this case, for features of the parts appearing in both the first still image and the second still image, the parts appearing in the second still image are adopted. As a result, the N integrated feature values being computed indicate a pose of standing with the left hand on the hip, as seen in the first still image, and simultaneously raising the right hand, as seen in the second still image.

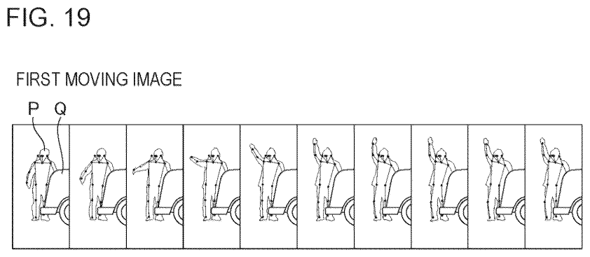

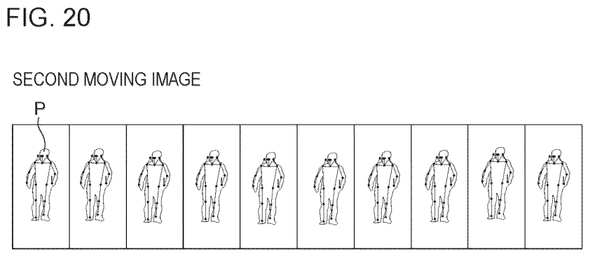

Further, in the present example embodiment, N key points of a plurality of human bodies P illustrated in FIGS. 19 and 20 can be integrated, for example. A moving image in FIG. 19 is an image acquired by capturing a person, who is in a standing position making a movement of raising the right hand, from the front side of the person. In a second moving image, parts of the left half body of the person are obscured by a vehicle Q. As a result, the key points included in the visible parts of the body of the person are detected, but the key points included in the obscured parts are not detected. A moving image in FIG. 20 is an image acquired by capturing a person, who is in a standing position with the hand on the hip. In the second moving image, there is no obscured part of the body of the person. As a result, all the N key points are detected from the human body P. By integrating the feature values of the key points of the human bodies that are detected from the two moving images described above, missing parts in the first moving image are complemented with the second moving image, and thereby the integrated feature value associated with each of all the N key points can be computed. In this example, for example, the above-mentioned method in the fourth example, in other words, computation of the integrated feature value, based on the priority order of each of the M human bodies, may be performed. For example, a user specifies a higher priority for the human body included in the first moving image over the one included in the second moving image. In this case, for features of the parts appearing in both the first moving image and the second moving image, the parts appearing in the first moving image are adopted. In this case, time-series data relating to the N integrated feature values being computed indicate a movement of placing the left hand on the hip, as seen in the second moving image, and raising the right hand in a standing position, as seen in the first moving image.

Note that, the M human bodies may be a human body of one person, or may be human bodies of different persons.

### Second Example Embodiment

An image processing apparatus 100 according to the present example embodiment is different from the first example embodiment in the details of the processing of integrating key points detected from each of M human bodies and computing an integrated feature value. In the first example embodiment, for example, the integrated feature value is computed by the flow illustrated in FIG. 14. In the present example embodiment, the image processing apparatus 100 integrates the key points detected from each of the M human bodies and computes the integrated feature value by a method specified by a user input. Details thereof are described below.

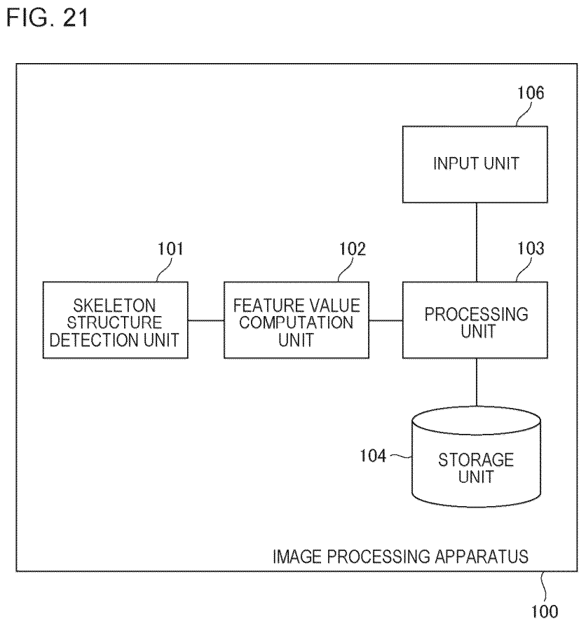

FIG. 21 illustrates one example of a function block diagram of the image processing apparatus 100 according to the present example embodiment. The image processing apparatus 100 illustrated herein includes a skeleton structure detection unit 101, a feature value computation unit 102, a processing unit 103, a storage unit 104, and an input unit 106. Note that, the image processing apparatus 100 may not include the storage unit 104. In this case, an external apparatus includes the storage unit 104. Further, the storage unit 104 is configured to be accessible from the image processing apparatus 100.

The input unit 106 receives a user input for specifying a method of integrating feature values of key points detected from each of M human bodies. The input unit 106 is capable of receiving the above-mentioned user input via an input apparatus of various types such as a touch panel, a keyboard, a mouse, a physical button, a microphone, and a gesture input apparatus.

By the method being specified by the user input, the processing unit 103 integrates the feature values detected from each of the M human bodies for each key point, and thereby computes the integrated feature value of each of the N key points.

The input unit 106 and the processing unit 103 are capable of executing any of the following processing examples 1 and 2.

### Processing Example 1

In this example, for each of the M human bodies, the input unit 106 performs an input of specifying a key point whose feature value is to be adopted. This indicates an input of specifying, for each key point, a human body from which a key point whose feature value is to be adopted is detected. Further, as the integrated feature value of a first key point, the processing unit 103 decides the feature value of the first key point detected from the human body specified by a user input.

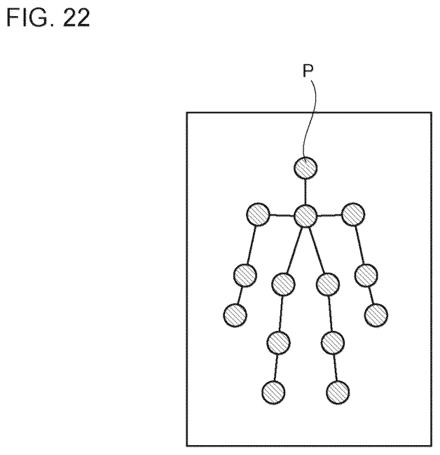

Various methods of receiving the user input may be adopted. For example, the input unit 106 may display a human body model in which N objects R associated with each of the N key points are arranged at associated skeleton positions of a human body, as illustrated in FIG. 22, and receive a user input of selecting an object associated with a key point whose computed feature value is adopted or an object associated with a key point not for adoption, for each of the M human bodies.

Alternatively, the input unit 106 may display names of body parts associated with a plurality of key points such as a head, a neck, a right shoulder 1, a left shoulder, a right elbow, a left elbow, a right hand, a left hand, a right hip, a left hip, a right knee, a left knee, a right foot, and a left foot, and receive a user input of selecting, among those, a key point whose computed feature value is adopted or a key point not for adoption in association with each of the M human bodies. In this case, a user interface (UI) member such as a check box may be used.

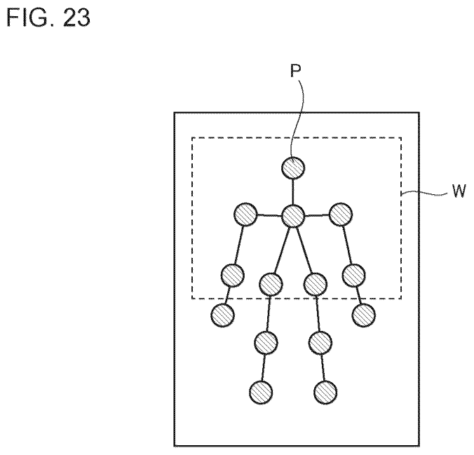

Alternatively, the input unit 106 may display a human body model in which N objects R associated with each of the N key points are arranged at associated skeleton positions of a human body, as illustrated in FIG. 23, and receive a user input of selecting at least one part of the body in the human body model. Further, the input unit 106 may decide a key point present in the body part selected by the user input, as a key point whose computed feature value is adopted or a key point whose computed feature value is not adopted. In the example illustrated in FIG. 23, at least a part of the body is selected by a frame W. A user performs adjustment by changing a position or a size of the frame W in such a way that the frame W includes a desired key point.

Alternatively, the input unit 106 may display names of one part of body such as an upper half body, a lower half body, a right half body, and a left half body, and receive a user input of selecting at least one among those. Further, the input unit 106 may decide a key point present in the body part selected by the user input, as a key point whose computed feature value is adopted or a key point whose computed feature value is not adopted. In this case, a user interface (UI) member such as a check box may be used.

### Processing Example 2

In this example, with respect to each of the M human bodies, the input unit 106 receives a user input of specifying a weight of a feature value computed from each of the M human bodies for each key point. Further, as the integrated feature value of each key point, the processing unit 103 computes a weighted average value according to the above-mentioned weight, which is specified by a user, of the feature value computed from each of the M human bodies.

Various methods of specifying a weight for each key point may be adopted. For example, the input unit 106 may receive an input of specifying a key point individually by the method described in the processing example 1, and then further receive an input of specifying a weight of the key point being specified. Alternatively, the input unit 106 may receive an input of specifying a part of the body by the method described in the processing example 1, and then further receive an input of specifying a weight being commonly shared by all the key points included in the part of the body being specified.

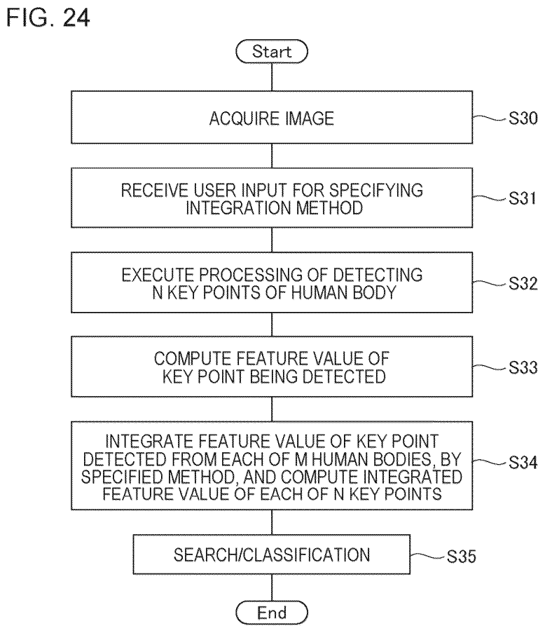

Next, one example of a flow of the processing executed by the image processing apparatus 100 is described with reference to the flowchart in FIG. 24. Note that, the processing order of each of the steps may be changed as appropriate.

First, the image processing apparatus 100 acquires at least one image (S30). Subsequently, the image processing apparatus 100 receives a user input for specifying a method of integrating feature values of key points detected from each of M human bodies (M is an integer equal to or greater than 2) (S31).

Subsequently, the image processing apparatus 100 executes processing of detecting the N key points from each of the M human bodies included in the at least one image being acquired (S32). From each of the human bodies, all the N key points may be detected, or only some of the N key points may be detected.

Subsequently, the image processing apparatus 100 computes a feature value of the key point being detected for each of the human bodies (S33). Subsequently, by the method specified in S31, the image processing apparatus 100 integrates the feature values of the key points detected from each of the M human bodies, and thereby computes an integrated feature value of each of the N key points (S34). Subsequently, the image processing apparatus 100 performs an image search or image classification, based on the integrated feature value computed in S34 (S35).

Other configurations of the image processing apparatus 100 according to the present example embodiment are similar to those in the first example embodiment.

According to the image processing apparatus 100 according to the present example embodiment, an advantageous effect similar to that in the first example embodiment can be achieved. Further, a user can specify an integration method, and hence an integrated feature value desirable for a user can be computed.

### Third Example Embodiment

An image processing apparatus 100 according to the present example embodiment includes a function of outputting information for discriminating between a key point that has an integrated feature value computed thereat and a key point that does not have an integrated feature value computed thereat. Details thereof are described below.

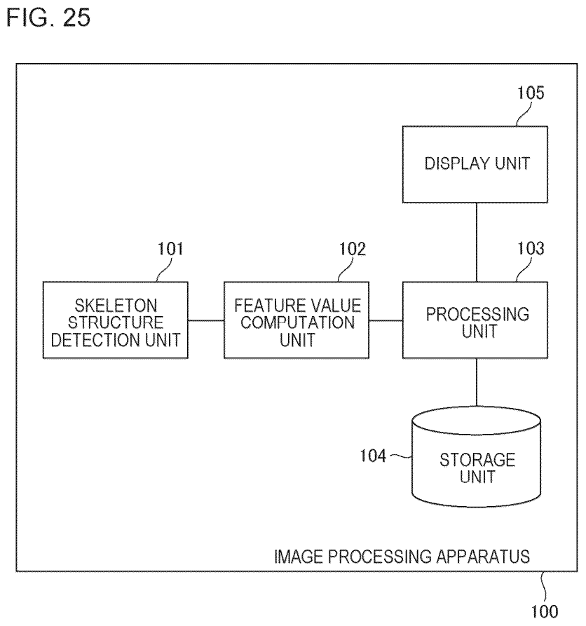

FIG. 25 illustrates one example of a function block diagram of the image processing apparatus 100 according to the present example embodiment. The image processing apparatus 100 illustrated herein includes a skeleton structure detection unit 101, a feature value computation unit 102, a processing unit 103, a storage unit 104, and a display unit 105.

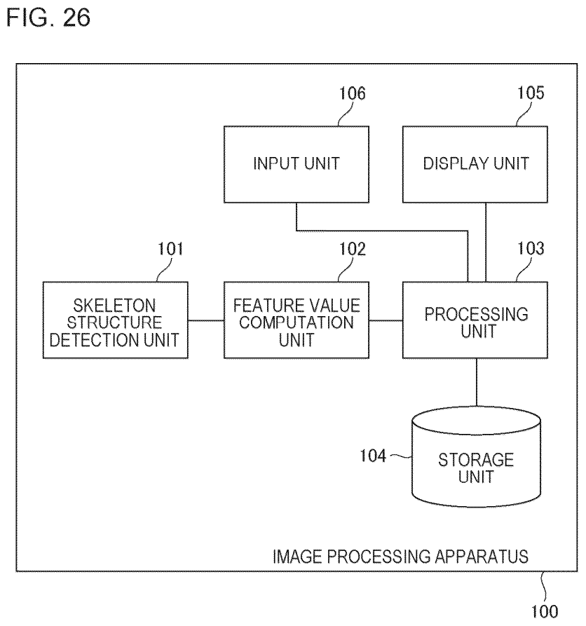

FIG. 26 illustrates another example of a function block diagram of the image processing apparatus 100 according to the present example embodiment. The image processing apparatus 100 illustrated herein includes the skeleton structure detection unit 101, the feature value computation unit 102, the processing unit 103, the storage unit 104, the display unit 105, and an input unit 106.

Note that, the image processing apparatus 100 may not include the storage unit 104. In this case, an external apparatus includes the storage unit 104. Further, the storage unit 104 is configured to be accessible from the image processing apparatus 100.

The display unit 105 displays information for discriminating between a key point that is not detected from any of M human bodies specified by a user and does not have an integrated feature value computed thereat, and a key point that is detected at least one of the M human bodies and has an integrated feature value computed thereat.

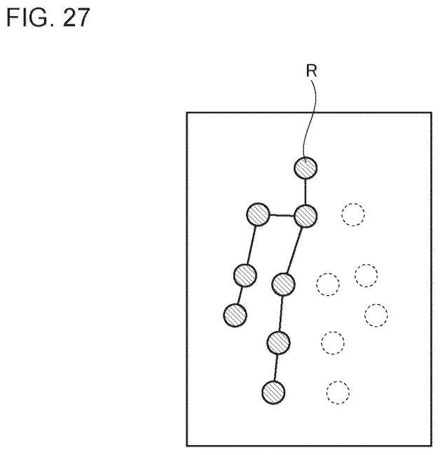

For example, the display unit 105 may display a human body model in which N objects R associated with each of the N key points are arranged at associated skeleton positions of a human body, as illustrated in FIG. 27, and display an object associated with a key point that does not have an integrated feature value computed thereat and an object associated with a key point that is detected from at least one of the M human bodies and has an integrated feature value computed thereat, in a discriminable manner. A method of performing display in a discriminable manner may be achieved by filling an object or not, as illustrated in FIG. 27, but is not limited thereto. Examples of alternative methods include, for example, differing colors of the objects, differing shapes of the objects, and displaying, in a highlighted manner, by flashing or the like an object associated with a key point that has an integrated feature value computed thereat or a key point that does not have an integrated feature value computed thereat.

Note that, the display unit 105 may further display information for discriminating between a key point being detected from each of the M human bodies and a key point not being detected therefrom, in association with each of the M human bodies specified by a user. In other words, the display unit 105 may further display information for discriminating between a part from which a key point is detected and a part from which a key point is not detected. The display may be achieved by a method similar to the method described with reference to FIG. 27.

Other configurations of the image processing apparatus 100 according to the present example embodiment are similar to those in the first and second example embodiments.

According to the image processing apparatus 100 according to the present example embodiment, an advantageous effect similar to that in the first and second example embodiments can be achieved. Further, according to the image processing apparatus 100 according to the present example embodiment, a user can easily recognize which of the N key points is covered in the M human bodies being specified, based on the information displayed by the display unit 105. Further, by using the image as illustrated in FIG. 27, a user can intuitively recognize an above-mentioned content. As a result, a user can recognize which human body to add in order to generate the integrated feature values of all the N key points.

While the example embodiments of the present invention have been described with reference to the drawings, the example embodiments are only exemplification of the present invention, and various configurations other than the above-described example embodiments can also be employed. The configurations of the example embodiments described above may be combined with each other, or some of the configurations may be replaced with others of the configurations. Further, various changes may be made to the configurations of the example embodiments described above without departing from the gist. Further, the configurations or the processing that are disclosed in the example embodiments and the modification examples described above may be combined with each other.

Further, in the plurality of flowcharts used in the description given above, the plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments described above may be combined with each other within a range where the contents do not conflict with each other.

The whole or a part of the example embodiments described above can be described as, but not limited to, the following supplementary notes.
1. An image processing apparatus, including:
   a skeleton structure detection unit that executes processing of detecting a plurality of key points associated with each of a plurality of parts of a human body included in an image;
   a feature value computation unit that computes a feature value of each of the key points being detected; and
   a processing unit that computes an integrated feature value of each of the parts by integrating the feature values detected from a plurality of human bodies for each of the parts, and performs an image search or image classification, based on the integrated feature value, wherein,
   when the key point associated with a first part of the plurality of parts is not detected from some of the plurality of human bodies, and the key point associated with the first part is detected from others of the plurality of human bodies, the processing unit computes the integrated feature value of the first part, based on the feature value of the key point associated with the first part detected from the others.
2. The image processing apparatus according to supplementary note 1, wherein,
   when the key point associated with the first part is detected from one human body of the plurality of human bodies, the processing unit regards, as the integrated feature value of the first part, the feature value of the key point associated with the first part detected from the one human body.
3. The image processing apparatus according to supplementary note 1 or 2, wherein,
   when the key points associated with the first part are detected from a plurality of human bodies of the plurality of human bodies, the processing unit regards, as the integrated feature value of the first part, a statistic value of the feature values of the key points associated with the first part detected from the plurality of human bodies.
4. The image processing apparatus according to supplementary note 1 or 2, wherein,
   when the key points associated with the first part are detected from a plurality of human bodies of the plurality of human bodies, the processing unit regards, as the integrated feature value of the first part, the feature value having a highest certainty factor among the feature values of the key points associated with the first part detected from the plurality of human bodies.
5. The image processing apparatus according to supplementary note 1 or 2, wherein,
   when the key points associated with the first part are detected from a plurality of human bodies of the plurality of human bodies, the processing unit regards, as the integrated feature value of the first part, a weighted average value of the feature value of the key point associated with the first part according to a certainty factor of the feature value of the key point associated with the first part detected from each of the plurality of human bodies.
6. The image processing apparatus according to any one of supplementary notes 1 to 5, further including
   a display unit that displays information for discriminating between the part in which the key point is not detected from any of the plurality of human bodies and the integrated feature value is not computed, and the part in which the key point is detected from at least one of the plurality of human bodies and the integrated feature value is computed.
7. The image processing apparatus according to supplementary note 6, wherein
   the display unit displays a human body model in which a plurality of objects are arranged in the parts of a human body, and also displays the object associated with the part in which the integrated feature value is computed and the object associated with the part in which the integrated feature value is not computed, in a discriminable manner.
8. The image processing apparatus according to supplementary note 6 or 7, wherein
   the display unit further displays information for discriminating between the part in which the key point is detected and the part in which the key point is not detected, in association with each of the plurality of human bodies.
9. An image processing method including,
   by a computer executing:
   a skeleton structure detection step of executing processing of detecting a plurality of key points associated with each of a plurality of parts of a human body included in an image;
   a feature value computation step of computing a feature value of each of the key points being detected; and
   a processing step of computing an integrated feature value of each of the parts by integrating the feature values detected from a plurality of human bodies for each of the parts, and performing an image search or image classification, based on the integrated feature value,
   the image processing method further including,
   by the computer,
   in the processing step, when the key point associated with a first part of the plurality of parts is not detected from some of the plurality of human bodies, and the key point associated with the first part is detected from others of the plurality of human bodies, computing the integrated feature value of the first part, based on the feature value of the key point associated with the first part detected from the others.
10. A program causing a computer to function as:
   a skeleton structure detection unit that executes processing of detecting a plurality of key points associated with each of a plurality of parts of a human body included in an image;
   a feature value computation unit that computes a feature value of each of the key points being detected; and
   a processing unit that computes an integrated feature value of each of the parts by integrating the feature values detected from a plurality of human bodies for each of the parts, and performs an image search or image classification, based on the integrated feature value, wherein,
   when the key point associated with a first part of the plurality of parts is not detected from some of the plurality of human bodies, and the key point associated with the first part is detected from others of the plurality of human bodies, the processing unit computes the integrated feature value of the first part, based on the feature value of the key point associated with the first part detected from the others.

### Reference Signs List

100 Image processing apparatus
101 Skeleton structure detection unit
102 Feature value computation unit
103 Processing unit
104 Storage unit
105 Display unit
106 Input unit
1A Processor
2A Memory
3A Input/output I/F
4A Peripheral circuit
5A Bus

What is claimed is:

1. An image processing apparatus, comprising:
at least one memory configured to store one or more instructions; and
at least one processor configured to execute the one or more instructions to:
execute processing of detecting a plurality of key points associated with each of a plurality of parts of a human body included in an image;
compute a feature value of each of the key points being detected;
compute an integrated feature value of each of the parts by integrating the feature values detected from a plurality of human bodies for each of the parts, and perform an image search or image classification, based on the integrated feature value, and
when the key point associated with a first part of the plurality of parts is not detected from some of the plurality of human bodies, and the key point associated with the first part is detected from others of the plurality of human bodies, compute the integrated feature value of the first part, based on the feature value of the key point associated with the first part detected from the others.

2. The image processing apparatus according to claim 1, wherein the at least one processor is further configured to execute the one or more instructions to,
when the key point associated with the first part is detected from one human body of the plurality of human bodies, regard, as the integrated feature value of the first part, the feature value of the key point associated with the first part detected from the one human body.

3. The image processing apparatus according to claim 1, wherein the at least one processor is further configured to execute the one or more instructions to,
when the key points associated with the first part are detected from a plurality of human bodies of the plurality of human bodies, regard, as the integrated feature value of the first part, a statistic value of the feature values of the key points associated with the first part detected from the plurality of human bodies.

4. The image processing apparatus according to claim 1, wherein the at least one processor is further configured to execute the one or more instructions to,
when the key points associated with the first part are detected from a plurality of human bodies of the plurality of human bodies, regard, as the integrated feature value of the first part, the feature value having a highest certainty factor among the feature values of the key points associated with the first part detected from the plurality of human bodies.

5. The image processing apparatus according to claim 1, wherein the at least one processor is further configured to execute the one or more instructions to,
when the key points associated with the first part are detected from a plurality of human bodies of the plurality of human bodies, regard, as the integrated feature value of the first part, a weighted average value of the feature value of the key point associated with the first part according to a certainty factor of the feature value of the key point associated with the first part detected from each of the plurality of human bodies.

6. The image processing apparatus according to claim 1, wherein the at least one processor is further configured to execute the one or more instructions to
display information for discriminating between the part in which the key point is not detected from any of the plurality of human bodies and the integrated feature value is not computed, and the part in which the key point is detected from at least one of the plurality of human bodies and the integrated feature value is computed.

7. The image processing apparatus according to claim 6, wherein the at least one processor is further configured to execute the one or more instructions to
display a human body model in which a plurality of objects are arranged in the parts of a human body, and also display the object associated with the part in which the integrated feature value is computed and the object associated with the part in which the integrated feature value is not computed, in a discriminable manner.

8. The image processing apparatus according to claim 6, wherein the at least one processor is further configured to execute the one or more instructions to
display information for discriminating between the part in which the key point is detected and the part in which the key point is not detected, in association with each of the plurality of human bodies.

9. An image processing method comprising,
by a computer executing:
executing processing of detecting a plurality of key points associated with each of a plurality of parts of a human body included in an image;
computing a feature value of each of the key points being detected;
computing an integrated feature value of each of the parts by integrating the feature values detected from a plurality of human bodies for each of the parts, and performing an image search or image classification, based on the integrated feature value, and
when the key point associated with a first part of the plurality of parts is not detected from some of the plurality of human bodies, and the key point associated with the first part is detected from others of the plurality of human bodies, computing the integrated feature value of the first part, based on the feature value of the key point associated with the first part detected from the others.

10. A non-transitory storage medium storing a program causing a computer to:
execute processing of detecting a plurality of key points associated with each of a plurality of parts of a human body included in an image;
compute a feature value of each of the key points being detected;
compute an integrated feature value of each of the parts by integrating the feature values detected from a plurality of human bodies for each of the parts, and performs an image search or image classification, based on the integrated feature value, and
when the key point associated with a first part of the plurality of parts is not detected from some of the plurality of human bodies, and the key point associated with the first part is detected from others of the plurality of human bodies, compute the integrated feature value of the first part, based on the feature value of the key point associated with the first part detected from the others.

11. The image processing method according to claim 9, wherein the computer,
when the key point associated with the first part is detected from one human body of the plurality of human bodies, regards, as the integrated feature value of the first part, the feature value of the key point associated with the first part detected from the one human body.

12. The image processing method according to claim 9, wherein the computer,
when the key points associated with the first part are detected from a plurality of human bodies of the plurality of human bodies, regards, as the integrated feature value of the first part, a statistic value of the feature values of the key points associated with the first part detected from the plurality of human bodies.

13. The image processing method according to claim 9, wherein the computer,
when the key points associated with the first part are detected from a plurality of human bodies of the plurality of human bodies, regards, as the integrated feature value of the first part, the feature value having a highest certainty factor among the feature values of the key points associated with the first part detected from the plurality of human bodies.

14. The image processing method according to claim 9, wherein the computer,
when the key points associated with the first part are detected from a plurality of human bodies of the plurality of human bodies, regards, as the integrated feature value of the first part, a weighted average value of the feature value of the key point associated with the first part according to a certainty factor of the feature value of the key point associated with the first part detected from each of the plurality of human bodies.

15. The image processing method according to claim 9, wherein the computer
displays information for discriminating between the part in which the key point is not detected from any of the plurality of human bodies and the integrated feature value is not computed, and the part in which the key point is detected from at least one of the plurality of human bodies and the integrated feature value is computed.

16. The non-transitory storage medium according to claim 10, wherein the program causing the computer to,
when the key point associated with the first part is detected from one human body of the plurality of human bodies, regard, as the integrated feature value of the first part, the feature value of the key point associated with the first part detected from the one human body.

17. The non-transitory storage medium according to claim 10, wherein the program causing the computer to,
when the key points associated with the first part are detected from a plurality of human bodies of the plurality of human bodies, regard, as the integrated feature value of the first part, a statistic value of the feature values of the key points associated with the first part detected from the plurality of human bodies.

18. The non-transitory storage medium according to claim 10, wherein the program causing the computer to,
when the key points associated with the first part are detected from a plurality of human bodies of the plurality of human bodies, regard, as the integrated feature value of the first part, the feature value having a highest certainty factor among the feature values of the key points associated with the first part detected from the plurality of human bodies.

19. The non-transitory storage medium according to claim 10, wherein the program causing the computer to,
when the key points associated with the first part are detected from a plurality of human bodies of the plurality of human bodies, regard, as the integrated feature value of the first part, a weighted average value of the feature value of the key point associated with the first part according to a certainty factor of the feature value of the key point associated with the first part detected from each of the plurality of human bodies.

20. The non-transitory storage medium according to claim 10, wherein the program causing the computer to
display information for discriminating between the part in which the key point is not detected from any of the plurality of human bodies and the integrated feature value is not computed, and the part in which the key point is detected from at least one of the plurality of human bodies and the integrated feature value is computed.
